(19) United States
(12) Patent Application Publication
(10) Pub. No.: US 2024/0203245 A1
(43) Pub. Date: Jun. 20, 2024

(54) TRAFFIC MONITORING SYSTEM FOR AN ESTABLISHMENT AND A METHOD THEREOF

(71) Applicant: Honda Motor Co., Ltd., Tokyo (JP)

(72) Inventors: Matt Komich, Denver, CO (US); Rajeev Chhajer, Powell, OH (US)

(21) Appl. No.: 18/066,927

(22) Filed: Dec. 15, 2022

(51) Int. Cl. G08G 1/01; G08G 1/09

(52) U.S. Cl. CPC G08G 1/0129; G08G 1/091

(57) ABSTRACT

A traffic monitoring system includes a locator configured to receive one or more data including a point of interest of one or more vehicles present inside a geographic zone defined around an establishment. The traffic monitoring system also includes a traffic predictor arranged in communication with the locator and configured to determine enroute vehicles to the established based on the one or more data received from the locator. The traffic predictor is also configured to notify an information corresponding to the enroute vehicles to the establishment.

### BACKGROUND

The disclosure relates generally to a traffic monitoring system. More particularly, this disclosure relates to a traffic monitoring system suitable to determine incoming traffic to an establishment and a method thereof.

Estimating inflow of customer traffic in a commercial establishment, such as, a restaurant, provides valuable information to the management of the establishment. Management may use the estimated customer traffic for staffing and security decisions to ensure timely delivery of the services to the customers. Furthermore, accurate customer traffic information enables a judicious use of available resources to reduce or manage the wait time before the service is delivered to the customers. Therefore, there exist a need that helps in estimating the incoming traffic to commercial establishment.

### SUMMARY

In accordance with one embodiment of the present disclosure, a traffic monitoring system is provided. The traffic monitoring system may include a locator configured to receive data including a point of interest of one or more vehicles present inside a geographic zone defined around an establishment. The traffic monitoring system may also include a traffic predictor arranged in communication with the locator and configured to determine enroute vehicles to the established based on the data received from the locator. The traffic predictor may also be configured to notify information related to the enroute vehicles to a device at the establishment.

In accordance with another embodiment of the present disclosure, a method for monitoring incoming traffic to an establishment is provided. The method may include receiving data having a point of interest related to one or more vehicles present inside a geographic zone defined around the establishment. The method may also include determining enroute vehicles to the establishment based on the received data. Moreover, the method includes providing information related to the enroute vehicles to a device at the establishment.

In accordance with yet a further embodiment of the present disclosure, a traffic monitoring system is disclosed. The traffic monitoring system may include a locator configured to receive one or more destinations of one or more vehicles present inside a geographic zone defined around an establishment. The traffic monitoring system may also include a traffic predictor arranged in communication with the locator and configured to determine enroute vehicles to the establishment based on the one or more destinations received from the locator of the one or more vehicles. Moreover, the traffic predictor may be configured to provide a count of enroute vehicles and associated time of arrival at the establishment to a device at the establishment.

### BRIEF DESCRIPTION OF THE DRAWINGS

Certain embodiments of the present disclosure will be better understood from the following description taken in conjunction with the accompanying drawings in which:

FIG. 1 is a block diagram depicting an exemplary traffic monitoring system arranged in communication with an establishment in accordance with one embodiment of the present disclosure; and

FIG. 2 is a block diagram of an exemplary processor system structured to execute instructions to implement the traffic monitoring system and a method performed by the traffic monitoring system to determine incoming traffic to the establishment in accordance with one embodiment of the present disclosure.

### DETAILED DESCRIPTION OF EXEMPLARY EMBODIMENTS

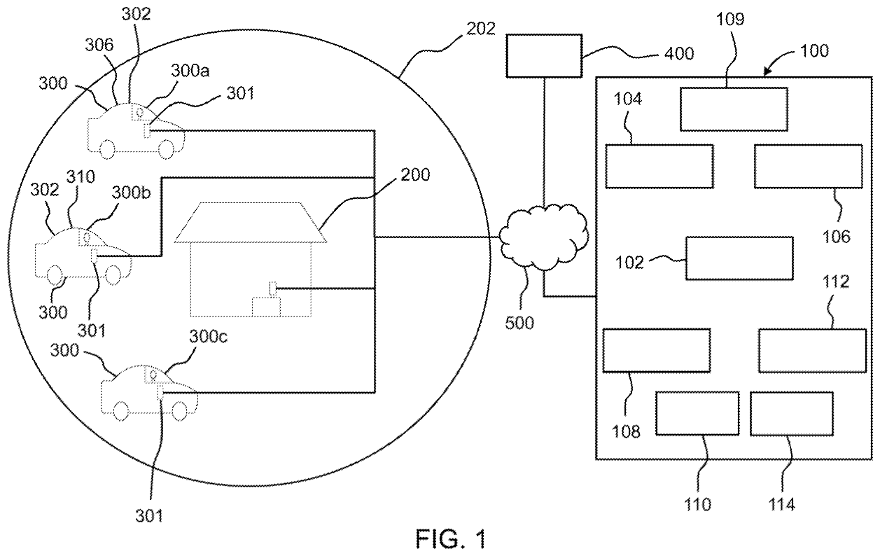

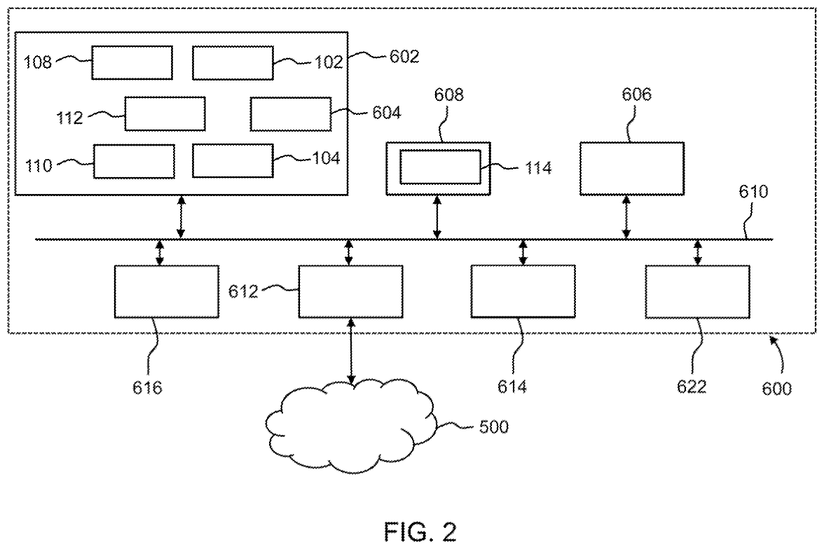

Exemplary embodiments are described to illustrate the disclosed subject matter, not to limit its scope, which is defined by the claims. Those of ordinary skill in the art will recognize a number of equivalent variations of the various features provided in the description that follows. Embodiments are hereinafter described in detail in connection with the views and examples of FIGS. 1-2, wherein like numbers indicate the same or corresponding elements throughout the views.

FIG. 1 is a block diagram depicting an exemplary environment depicting an establishment, for example, a commercial establishment 200, a plurality of vehicles 300, a global navigation satellite system (GNSS) 400, a network 500, and a traffic monitoring system 100 having an incoming traffic predictor 102 configured to monitor/determine/estimate an incoming traffic to the commercial establishment 200 is shown. In an implementation, the traffic monitoring system 100 and various sub-systems or the modules of the traffic monitoring system 100 may be implemented using a server and may be accessed via a user device. In some embodiments, various sub-systems, or the modules of the traffic monitoring system 100, may be implemented using a local computing device, for example, a tablet. In the illustrated example, the traffic monitoring system 100 may be configured to collect data from the vehicles 300, the GNSS 400 and/or other data sources to enable the incoming traffic predictor 102 to determine/estimate/predict incoming traffic (a total number of vehicles enroute to the commercial establishment 200) to the commercial establishment 200 and associated time-of-arrival (ETA).

Each of the vehicles 300 (e.g., a car, a van, a truck, etc.) may include a navigation module 301 having a user interface (e.g., a human-machine interface installed in the dashboard) that collects point-of-interest data from a passenger (e.g., a driver) of the vehicles 300. The POI data identifies a point-of-interest, that is a destination for the vehicle 300. The GNSS 400 may provide location data 120 that indicates a current location of the vehicles 300, for example, as the vehicles 300 travel to the commercial POI. In an embodiment, the traffic monitoring system 100 may include a locator 104 configured to determine a location of the commercial establishment 200 and create a geographic zone of interest 202 around the commercial establishment 200. In an embodiment, the zone of interest 202 (herein simply referred to as zone) is established based on an input received from the commercial establishment 200. The zone 202 may be a circular zone that includes a radius of a predefined distance with the commercial establishment 200 as its center. In some embodiments, the predefined distance may be received as an input from the commercial establishment 200 when the commercial establishment 200 subscribes to the traffic monitoring system 100. In some embodiment, the predefined distance may be changed based on the inputs from the commercial establishment 200.

The locator 104 may be configured to communicate with the GNSS 400 and determines/identifies the vehicles 300 present in the zone 202. The locator 104 may identify the POI of each of the vehicles 300 based on the data received from the GNSS 400 and/or the map data/navigation module 301 of the vehicles 300 identified inside the zone 202. Based on the received data, the traffic predictor 102 determines, estimates, predicts, and/or identifies vehicles enroute to the commercial establishment 200 (hereinafter referred to as enroute vehicles 302) out of the vehicles 300 present inside the zone 202, and determines a count of the vehicles 302 enroute to the commercial establishment 200.

In an embodiment, the traffic predictor 102 determines and/or identifies the vehicles 300 having the POI as the commercial establishment 200, and categorizes such vehicles 300 as a first set of vehicles 306. For example, the traffic predictor 102 may determine the POI for the first vehicle 300a as the commercial establishment 200 and includes the first vehicle 300a in the first set of vehicles 306.

In some embodiments, the POI data may be unavailable for one or more of the vehicles 300, for example, the second and third vehicle 300b, 300c that are present in the zone 202. In such a scenario, the traffic predictor 102 may predict whether the one or more vehicles 300b, 300c is enroute to the commercial establishment 200 based on one or more parameters. In some embodiments, the one or more parameters may include a heading/direction of movement of such vehicles, for example, the vehicles 300b, 300c, and the route on which such vehicles 300b, 300c are travelling inside the zone 202. Moreover, the one or more parameters may include a vehicle identification number, for example, a registration number or a license plate number of the vehicle, and historical data related to visit of such vehicles, for example, vehicles 300b, 300c to the commercial establishment 200. Moreover, the one or more parameters may also include a date, a time, weather condition, a day of the week, a month, etc. Also, one or more parameters may include a frequency of visit to the commercial establishment 200 by such vehicles, for example, vehicles 300b, 300c out of the total number of times such vehicles 300b, 300c are present in the zone 202.

Based on the one or more parameters, the traffic predictor 102 may predict that the one or more of the vehicles 300b, 300c, for example, the second vehicle 300b out of the vehicles 300b, 300c is enroute to the commercial establishment 200. In an embodiment, the traffic predictor 102 may use one or more of probabilistic model that may include a machine learning algorithm to identify/predict the vehicles, for example, the vehicle 300b out of the vehicles 300b, 300c that are enroute to the commercial establishment 200 for which POI data is unavailable. Also, the traffic predictor 102 may categorize or assign vehicles, for example, the second vehicle 300b, as a second set of vehicles 310. Accordingly, the traffic predictor 102 may calculate the number of enroute vehicles 302 as summation of a first set of vehicles 306 and a second set of vehicles 310.

Subsequent to the estimation/determination of the enroute vehicle 302, the traffic predictor 102 provides information or data related to the number of enroute vehicles 302 and associated ETA for the enroute vehicles 302 to a device, for example, a desktop, a laptop, a tablet, a mobile phone, or any other suitable device, at the commercial establishment 200. In an embodiment, the traffic predictor may calculate an ETA for each of the enroute vehicles 302 based on associated locations of the enroute vehicles, speed of the enroute vehicles, traffic on the route the enroute vehicles are moving, etc. In some embodiments, in which the traffic predictor 102 determines and/or identifies the second set of vehicles 310, the traffic predictor 102 may provide the information about the number of enroute vehicles 302 to the commercial establishment 200 as a range with a maximum value and a minimum value. The traffic predictor 102 may determine the maximum value by summing the first set of vehicles 306 and the second set of vehicles 310, while the minimum value corresponds to the first set of vehicles 306 only. In some embodiments, the traffic predictor 102 is configured to determine only the first set of vehicles 306 as the enroute vehicles 302. In such a case, the traffic predictor 102 may provide a single value for the enroute vehicles 302 to the commercial establishment 200.

The traffic monitoring system 100 may include a user interface 106. The traffic predictor 102 may provide the count of enroute vehicles 302 and associated ETAs to the commercial establishment 200 for display on the user interface 106. In an embodiment, the concerned person of the commercial establishment may access the user interface 106 via the suitable device, such as, but not limited to, a desktop computer, a laptop, a tablet, a mobile phone, or any other suitable device known in the art. The user interface may be viewed by accessing a web-based application installed on a computing system, for example, a computer, a laptop, a mobile phone, a tablet etc.

Additionally, or alternatively, the traffic monitoring system 100 may be configured to share information via one or more notifications to the commercial establishment 200 via the user device. In some embodiments, the traffic monitoring system 100 may include a notifier 108 arranged in communication with the traffic predictor 102, that communicates with the user device via a suitable communication device 109. The communication device 109 facilitates an exchange of data between the user devices and the traffic monitoring system 100 through a cellular network, internet, Wi-Fi, or any other mode of communicate mode known in the art.

In an embodiment, the notifier 108 shares/provides information/notifications about the number of enroute vehicles 302 and associated ETAs with the commercial establishment 200 when the total number of predicted/estimated/determined enroute vehicles 302 is above a threshold value. For example, the traffic monitoring system 100 (i.e., the notifier 108) sends and/or shares the information and/or one or more notifications on the user device of the commercial establishment 200 when the traffic predictor 102 determines that ten (10) or more vehicles, for example, are enroute to the commercial establishment 200. In an embodiment, the notifier 108 shares the information/notifications via the web-based application installed on the user device. In some embodiments, the notifier 108 may access a mobile phone number associated with the commercial establishment 200 and shares the information and/or one or more notifications as a text message to the mobile phone of the commercial establishment 200.

Based on the data received from the traffic predictor 102 (i.e., traffic monitoring system 100), the concerned person of the commercial establishment 200 may determine a total demand of the service provided by the commercial establishment 200 and notify the staff of the commercial establishment 200 about the predicted incoming traffic. Also, based on the predicted incoming traffic, the concerned person may determine a wait time at the commercial establishment 200, and may inform and/or notify the enroute vehicles 302 about the wait time at the commercial establishment 200 before the service may be provided to them. The commercial establishment 200 may determine the wait time based on a current queue condition, the estimate arrival of the incoming traffic, and/or a time taken to provide a given service to a customer.

In some embodiments, the traffic monitoring system 100 may include a queue manager 110 configured to estimate/determine a wait time or a queue condition at the commercial establishment 200 based on a current queue condition at the commercial establishment 200 and the predicted incoming traffic to the commercial establishment 200. In an embodiment, the queue manager 110 may determine the current queue condition base on a historical data. For example, the queue manager 110 uses the historical queue conditions, time, day, date, current weather conditions, etc., and estimates the current queue condition at the commercial establishment 200. In some embodiment, the queue manager 110 may receive inputs from the commercial establishment 200 and determines the current queue condition based on such input. In some embodiments, the commercial establishment may include one or more sensors, for example, one or more cameras, and determine the current queue condition based on the inputs received from such sensors.

Based on the estimated current queue condition and predicted incoming traffic data, the queue manager 110 may determine and/or estimate a predicted queue condition for each of the enroute vehicles 302 reaching the commercial establishment 200, and may notify the enroute vehicles/persons 302 about the estimated wait time at the commercial establishment 200 on reaching the commercial establishment 200. To share one or more notifications to the enroute vehicles 302, the traffic monitoring system 100 may include a message manager 112. The message manager 112 is configured to generate suitable notifications based on the inputs from the queue manager 110 and/or the inputs received from the concerned person via the user interface 106. The message manager 112 may be configured to share the notifications to the incoming traffic, i.e., enroute vehicles 302, via one or more user devices of the enroute vehicles 302. For example, the message manager 112 may access the user interfaces of the enroute vehicles 302 and shares the notification via the user interfaces of the enroute vehicles 302. In some embodiments, the message manager 112 may communicate with the user devices, such as, mobile phones, associated with the drivers of the enroute vehicles 302 and shares the notifications to the mobile phone of the drivers as a text message. In some embodiments, the message manager 112 or the traffic predictor 102 may request a permission from the drivers of the enroute vehicles 302 to share the notification messages either via the mobile phone or user interfaces devices of the enroute vehicles 302. Based on the permission received from the incoming traffic, the message manager 112 may share the suitable notifications to the incoming traffic.

The traffic monitoring system 100 may include a database 114 configured to store various demographic details, for example, age, sex, height, of the customers and associate the demographic details with an identifier, for example, a vehicle registration number or a mobile phone of the customer. The database 114 may store a list or information about the historical purchases of each customer. Based on the demographic details and/or purchase history of the customer, the traffic predictor 102 may be configured to notify the concerned person about a predicted demand of particular service. For example, for a coffee shop, the demographic information and past purchase history of those enroute, the traffic predictor 102 may determine and provide information whether a demand for baked goods is going to increase. In this manner, the traffic monitoring system 100 may facilitate in managing the services provided by the commercial establishment 200, and ensures a good delivery service to the customers. The traffic monitor system 100 may help the commercial establishment 200 to manage the increase in demands without compromising on the quality and deliver of the services to the customers.

FIG. 2 is a block diagram of an exemplary processor platform 600 structured to execute instructions to implement the system 100 and a method performed by the system 100 to determine incoming traffic to the commercial establishment 200. The processor platform 600 may be, for example, a server, a personal computer, a mobile device (e.g., a cell phone, a smart phone, a tablet such as an iPad), a personal digital assistant (PDA), an Internet appliance, a DVD player, a CD player, a digital video recorder, a Blu-ray player, a gaming console, a personal video recorder, a set top box, or any other type of computing device.

The processor platform 600 may include a processor 602 that may be implemented by one or more integrated circuits, logic circuits, microprocessors or controllers from any desired family or manufacturer. The processor 602 may include the traffic predictor 102, the notifier 108, the locator 104, the message manager 112 and/or the queue manager 110. The processor 602 may include a local memory 604 (e.g., a cache). The processor 602 is in communication with a main memory that includes a volatile memory 606 and a non-volatile memory 608 via a bus 610. The volatile memory 606 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 608 may be implemented by flash memory and/or any other desired type of memory device and may include the database 114. Access to the main memory 606, 608 is controlled by a memory controller.

The processor platform 600 may also include an interface circuit 612. The interface circuit 612 may be implemented by any type of interface standard, such as an Ethernet interface, a universal serial bus (USB), and/or a PCI express interface. In the illustrated example, one or more input devices 614 are connected to the interface circuit 612. The input device 614 permits a user to enter data and commands into the processor 602. The input device may be implemented by, for example, an audio sensor, a microphone, a camera (still or video), a keyboard, a button, a mouse, a touchscreen, a track-pad, a trackball, and/or a voice recognition system. One or more output devices 616 are also connected to the interface circuit 612. The output devices 616 may be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 612 also includes a communication device such as a transmitter, a receiver, a transceiver, a modem and/or network interface card to facilitate exchange of data with external machines (e.g., computing devices of any kind) via the network 500 (e.g., an Ethernet connection, a digital subscriber line (DSL), a telephone line, coaxial cable, a cellular telephone system, etc.).

The processor platform 600 may also include one or more mass storage devices 622 for storing software and/or data. Examples of such mass storage devices 622 include floppy disk drives, hard drive disks, compact disk drives, Blu-ray disk drives, RAID systems, and digital versatile disk (DVD) drives. Coded instruction to carry out the method performed by the system 100 may be stored in the mass storage device 622, in the volatile memory 606, and/or in the non-volatile memory 608.

The foregoing description of embodiments and examples has been presented for purposes of illustration and description. It is not intended to be exhaustive or to limit the invention to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the invention is, of course, not limited to the examples or embodiments set forth herein, but may be employed in any number of applications and equivalent devices by those of ordinary skill in the art. Rather it is hereby intended the scope of the invention be defined by the claims appended hereto.

What is claimed is:

1. A traffic monitoring system, comprising:
a locator configured to receive data including a point of interest of one or more vehicles present inside a geographic zone defined around an establishment; and
a traffic predictor arranged in communication with the locator and configured to:
determine enroute vehicles to the establishment based on the data received from the locator, and
provide information related to the enroute vehicles to a device at the establishment.

2. The traffic monitoring system of claim 1, wherein the information corresponding to the enroute vehicles includes a count of the enroute vehicles and associated time of arrival at the establishment.

3. The traffic monitoring system of claim 1, wherein the point of interest of the vehicle includes a destination of the vehicle obtained from a navigation module of the vehicle.

4. The traffic monitoring system of claim 1, wherein the enroute vehicles includes a first set of vehicles having the point of interest as the establishment.

5. The traffic monitoring system of claim 1, wherein the enroute vehicles includes a second set of vehicles and the traffic predictor determines the second set of the vehicles out of the one or more vehicles based on one or more parameters of the one or more vehicles arranged inside the geographic zone.

6. The traffic monitoring system of claim 5, wherein the one or more parameters includes a heading, a route of travel, a date, a time, a day of the week, a historical data related to the visits of the one or more vehicles to the establishment, or a combination thereof.

7. The traffic monitoring system of claim 1 further including a notifier arranged in communication with the traffic predictor and configured to provide the information corresponding to the enroute vehicles to the establishment when a count of the enroute vehicles is above a threshold value.

8. The traffic monitoring system of claim 1 further including a user interface and the traffic predictor provides the information related to the enroute vehicles to the device at the establishment via the user interface.

9. The traffic monitoring system of claim 1 further including a queue manager to determine a wait time at the establishment for each of the enroute vehicles based on the information received from the traffic predictor.

10. The traffic monitoring system of claim 9 further including a message manager arranged in communication with the queue manager and configured to share the associated wait time with one or more of the enroute vehicles.

11. A method for monitoring incoming traffic to an establishment, the method comprising:
receiving data including a point of interest of one or more vehicles present inside a geographic zone defined around the establishment;
determining enroute vehicles to the established based on the received data; and
providing information related to the enroute vehicles to a device at the establishment.

12. The method of claim 11, wherein the information related to the enroute vehicles includes a count of the enroute vehicles and associated time of arrival at the establishment.

13. The method of claim 11, wherein the point of interest of the vehicle includes a destination of the vehicle obtained from a navigation module of the vehicle.

14. The method of claim 11, wherein the enroute vehicles includes a first set of vehicles having the point of interest as the establishment.

15. The method of claim 11, wherein the enroute vehicles includes a second set of vehicles and determining the enroute vehicles includes estimating the second set of the vehicles out of the one or more vehicles based on one or more parameters of the one or more vehicles arranged inside the geographic zone.

16. The method of claim 11, wherein the information related to the enroute vehicles is provided to the device at the establishment when a count of the enroute vehicles is above a threshold value.

17. The method of claim 11 further including
determining a wait time at the establishment for each of the enroute vehicles, and
sharing the associated wait time with one or more of the enroute vehicles.

18. A traffic monitoring system, comprising:
a locator configured to receive one or more destinations of one or more vehicles present inside a geographic zone defined around an establishment; and
a traffic predictor arranged in communication with the locator and configured to
determine enroute vehicles to the established based on the one or more destinations, received from the locator, of the one or more vehicles, and
share a count of enroute vehicles and associated time of arrival at the establishment to a device at the establishment.

19. The traffic monitoring system of claim 18, wherein a notifier provides the count of the enroute vehicles and associated time of arrival at the establishment to a device at the establishment when the count of the enroute vehicles is above a threshold value.

20. The traffic monitoring system of claim 18 further including a message manager configured to share a wait time at the establishment with one or more of the enroute vehicles.
